(19) United States
(12) Patent Application Publication
(10) Pub. No.: US 2011/0027126 A1
(43) Pub. Date: Feb. 3, 2011

(54) METHOD OF LONG TERM STORAGE OF SUBSTRATE-COUPLED BEADS

(75) Inventors: Tanja Henzler, Mannheim (DE); Thomas Herget, Darmstadt (DE)

Correspondence Address: MILLEN, WHITE, ZELANO & BRANIGAN, P.C., 2200 CLARENDON BLVD., SUITE 1400, ARLINGTON, VA, 22201, US

(73) Assignee: Merck Patent Gesellschaft Mit Beschrankter Haftung, Darmstadt (DE)

(21) Appl. No.: 12/934,436

(22) PCT Filed: Mar. 13, 2009
(86) PCT No.: PCT/EP2009/001820

§ 371 Date: Sep. 24, 2010

(30) Foreign Application Priority Data
Mar. 26, 2008 (EP) 08005634.4

(51) Int. Cl. B01J 19/00

(52) U.S. Cl. 422/40

(57) ABSTRACT

The present invention relates to a method for a long term storage of substrate-coupled beads prepared for biological reactions, preferably enzymatic reactions. Suitable beads for this method may be inorganic or organic. Preferably polystyrene beads are used for this method.

### BACKGROUND OF THE INVENTION

For the development of new drugs with improved activity it is important to find specific targets playing a role in causing diseases. For this purpose and for the design of new therapeutic approaches assays are created, which are suitable to test a great number of targets in parallel, for example in 96-well plates. Different systems are developed in the past and are still improved. Very sophisticated screening systems, are based on the use of small tailored polymer beads, which are used in biomedical applications to simplify separations in biological systems, to localize biological interactions and to amplify the signal. In this area the researcher may choose a system which is suitable for his special screening problem.

TABLE 1
Comparison of bead characteristics (Drug Discovery Today,
Vol. 5, Supplement 1, 1 Jun. 2000, pages 38-41)

| Technology | Bead size | | Special properties |
|---|---|---|---|
| Scintillation Proximity | >2 | μm | “dyed” with scintillant |
| Assay | | | |
| Amplified Luminescence | 0.25 | μm | “dyed” with photo sensitizer, |
| Proximity Homogeneous | | | chemiluminescent molecule |
| Assay | | | and fluorophore |
| Fluorescence Energy | <1 | μm | “dyed” with paired energy |
| Transfer Latex | | | transfer fluorophores |
| Multiplexed Flow | 7.5 | μm | “dyed” with several intensities |
| Cytometry | | | of a single fluorophore |
| Luminex ®xMAP ™ | ≈6 | μm | “dyed” with two fluorophores in |
| | | | various ratios |
| Origen | ≈3 | μm | paramagnetic |
| Chugai Pharmaceuticals | ≈1 | μm | paramagnetic |
| Fluorometric Microvolume | 6-20 | μm | — |
| Assay Technology | | | |
| Laser Scanning Imaging | 6-8 | μm | — |
| Affymax micro volume | 10-78 | μm | — |
| fluorimetry | | | |
| Illumina | >0.5 | μm | — |
| Acumen | 3-6 | μm | Can be “dyed” with fluorophore |

All these bead-based technologies have been developed to facilitate easy separation or sensitive detection based on optical properties. Based on the flow cytometric analysis of beads, which have been internally dyed with two fluorophores of varying concentrations the Luminex® xMAP® system can for example currently assay up to 100 analytes in a single tube or well (J. Zimmermann, Micro array technology advances for therapeutic target discovery, Gen. Eng. News 19 (1999), p. 1-34). The proportion of orange to red internal fluorophores can distinguish separate sets of microspheres. Surface proteins, like streptavidin facilitate primary ligand attachment, while a green fluorescent label provides analyte quantitation. Because this method to identify a great number of target molecules in parallel is a very elegant procedure, it makes this analysis method in most cases to the tool of choice for the drug discovery process.

Especially the Luminex® xMAP® technology is mostly used. It is based on polystyrene beads, which are color coded with two different fluorescent dyes as described above (WO2006/044413 A2, U.S. Pat. No. 7,141,431 B2, EP 1 208 382 B1, WO 2007/103859 A2, WO 2006/044275 A2). The used beads show a mean diameter of ≈6 μm, and especially of about 5.6 μm.

The coding of these beads is achieved by adding them into a solvent containing a special mixture of fluorescent dyes. The beads swell up and take up the dyes by diffusion. After several washing steps, which are done in order to remove superfluous dye, the solvent is evaporated and the beads shrink to their original size with the encoding fluorescence dyes inside.

These encoded beads can be detected in special flow cytometers, using a laser, which detects the fluorescence of the beads itself, and another, which is used to detect a fluorescence reporter signal of coupled substances or macromolecules.

This means, when excited by a 635 nm laser the two fluorescent classifier dyes emit at different wavelengths (657 nm and 730 nm). The combination of different concentrations of these fluorescent dyes ends up in 100 different bead types. A third fluorescent dye is applied as a reporter. Such a reporter dye is for example Phycoerythrin, which is excited by a second laser (532 nm). The reporter fluorescent is an indicator for a positive reaction on the bead surface.

These 100 different bead regions will give the possibility for 100 parallel experiments, which can be done in a multiplex fashion in one well with one sample. Therefore, this system meets the needs of a wide variety of applications, as there are: protein expression profiling, focused gene expression profiling, autoimmune disease, genetic disease, molecular infectious disease, and HLA testing. The beads can easily be functionalized. The functionalization can take place with biomolecules, which are built from nucleotides or amino acids. Especially the beads can be functionalized by proteins, peptides or cyclic peptides.

In a preferred embodiment the beads as described are combined with antibodies or other binders, like scaffold proteins as there are for example anticalins, ancyrin repeat proteins, cystein-knot proteins, nanobodies and the like. In another preferred embodiment the beads are functionalized with enzymes, like phosphatases, kinases, lipases and so on. But they can also be functionalized with nucleotide sequences. These nucleotide sequences can occur as primers, DNA or RNA fragments, binding molecules, like aptamers or as larger DNA or RNA structures. The functionalization of said beads with for example antibodies or other structures can be achieved by covalent coupling by NHS-chemistry or by tags, which are captured by the corresponding affinity ligand, for example His-tag—Ni²⁺-NTA, GST-tag—glutathione, S-tag—S-protein.

The functionalized beads can be applied in biological reactions of analytical detection reactions. For these applications it is important, that the activity of the reactants is reliable and remains constant.

Typical applications for the Luminex® xMAP® technology as described above are sandwich immunoassays in which the capture antibody is coupled to the bead. The analyte is captured from a protein mixture, e.g. a cell lysate, and can be detected by a Phycoerythrin-labeled detection antibody. In consequence with this technology several conventional ELISAs can be done in one well in parallel.

Similar experiments can be done to detect protein-protein interactions, DNA-protein-interactions or to measure enzymatic reactions. These assays are of special interest for pharmaceutical research and development projects, academia and biotech companies. For example in WO 2007/009613 A1 a method for measuring tyrosine kinase phosphorylation is disclosed, which takes advantage of this technology.

Protein kinases are key regulators in most cellular signaling pathways in eukaryotic cells. Many protein kinase inhibitors have been developed to study specific functions of kinases in signaling pathways and as potential therapeutic agents (Cohen, P. Nat. Rev. Drug discov. (2000), 1, 309-315). Phosphorylations induced by tyrosine kinase seem to play a central role in cell cycle and intracellular pathways it seems to be very promising to deal with tyrosine kinase in drug targeting. Several approaches to target tyrosine kinases have been developed. Tyrosine kinase domain inhibitors, tyrosine kinase receptor blockers (e.g. monoclonal antibodies), ligand modulators (e.g. monoclonal antibodies), RNA interference and anti-sense technology, gene therapy strategy, inhibitors of receptor tyrosine kinases or downstream signal transduction pathway inhibitors are potential strategies for cancer therapy. Receptor tyrosine kinases are multi domain proteins. The catalytic domain (Mg-ATP complex binding site) has emerged as the most promising target for drug design in recent years. Random screening of compound libraries initially identified small molecule chemical inhibitors of the catalytic domain. Combinatorial chemistry, in-silico cloning, structure-based drug design, and computational chemistry have now become indispensable tools in lead compound identification and optimization of these inhibitors.

Because of the large size of the protein kinase super family (>500 members) and the fact that most kinase inhibitors bind in the highly conserved ATP-binding pocket, it is problematic, that kinase inhibitors sometimes inhibit more than one target (Davies, S. P., Reddy, H., Caivano, M & Cohen, P. Biochem. J. (2000) 351, 95-105).

Because of the huge variability of active kinases in living cells, great numbers of tests have to be proceeded. As a result highly sensitive, accurate, and reliable high throughput assays for screening inhibitors have been developed.

In case of the fluorescence dye marked beads the substrates needed for the enzymatic reactions can be coupled to the bead surface as such, and ATP and the respective enzymes (e.g. kinases) are added. In case of a phosphorylation the reaction can be detected by a phospho-specific antibody, which is Phycoerythrin-labeled. Since in each case a lot of different target molecules have to be screened, prepared beads have to be kept in stock with constant activity for a long period of time. This is a problem because of the limited shelf life of substrates coupled to bead surfaces. The substrates needed for said enzymatic reactions are in general based on proteins, which have to be stored at low temperatures (<−20° C.). But in spite of a storage at about 4° C. these substrates are degraded and inactivated after a couple of days. Especially the enzyme activity is lost. Additionally, providers recommend not to store substrate coupled materials at temperatures below freezing point of water. The provider of bead stocks for the xMAP®, technology, which are used in general, recommends to store these beads at 4° C. and not to freeze them. But it is a problem to keep substrate-coupled bead stocks in stock, if a great number of experiments and tests have to be carried out and if reproducible results are required for a long period of time.

Thus, there is a need for a method for a long-time storage of substrate-coupled bead stocks prepared for biological reactions, for example enzymatic reactions. Another aspect is to provide a method to keep the activity of the coupled biological molecules, fragments or structures especially the activity of coupled enzymes and of prepared substrate-coupled bead stocks steady during storage. In particular this method has to be carried out in a simple manner at reasonable conditions.

### SUMMARY OF THE INVENTION

The matter of the present invention relates to a method for a long-term storage of substrate-coupled beads, wherein the beads after the coupling reaction are cooled down in form of a suspension to low temperatures, especially to a temperature of at least about 4° C., and after cooling are stored until their use.

The matter of the present invention relates also to a method for a long-term storage of substrate-coupled beads, comprising the steps of adding at least one polyhydroxy alcohol or sugar to a suspension of substrate-coupled beads and storing the suspension.

In a preferred embodiment the method of the present invention comprises the steps of

a) adding at least one polyhydroxy alcohol or sugar to a suspension of substrate-coupled beads

and

b) shock freezing the resulting composition.

After shock freezing in the following long term storage [step c)] takes place at a low temperature, especially at the temperature to which the substrate-coupled bead suspension is cooled down.

In general the storage can be carried out at a temperature of about 4° C., but in a most preferred embodiment of the present invention in step c) the storage takes place at a temperature of at least 4° C., preferably at a lower temperature.

In a more preferred embodiment of the invention the storage of the frozen suspensions takes place at a temperature in the range of 4 up to −196° C., most preferred at a temperature in the range of −60 up to −100° C.

In a preferred embodiment the resulting composition of step a) is shock frozen in liquid nitrogen in step b).

In step a) of this method at least one polyhydroxy alcohol or sugar selected from the group glycerol, sorbitol, mannitol, isomalt, lactit, xylit, threit, erythrit, sucrose, fructose, trehalose, raffinose and glucose is added to the suspension of substrate coupled beads before freezing in step b). Preferably glycerol and/or sucrose is added in step a). In further preferred embodiments of the invention glycerol and/or trehalose or glycerol and/or fructose or glycerol and/or mannitol is added in step a).

In a most preferred embodiment of the invention the method of the present invention relates to a method of long term storage of substrate-coupled polystyrene beads.

If needed this improved storage method may be modified to a certain extent and in step a) not only at least one polyalcohol or polyhydroxy sugar may be added but also further additives with buffering and stabilizing properties.

In addition to this the matter of the present invention relates to a method as disclosed here, wherein the beads are coupled to chemical entities like small molecules or molecules built from nucleotides or amino acids or to proteins, peptides or cyclic peptides or to enzymes like phosphatases, kinases, lipases or others. It is also a matter of the present invention, that the beads are coupled to antibodies or other binders, scaffold proteins like anticalins, ancyrin repeat proteins, cystein-knot proteins, nanobodies, and others. The beads may also be coupled to nucleotide sequences, like primers, DNA or RNA fragments, binding molecules like apatamers, larger DNA or RNA structures.

In a preferred embodiment of the present invention the beads are coupled to enzymes like phosphatases, kinases, lipases or others. Most preferred the beads are coupled to kinases.

### DETAILED DESCRIPTION OF THE INVENTION

Now, contrary to expectations it has been found, that the problem described above can be solved by freezing substrate-coupled bead stocks prepared for biological reactions like enzymatic reactions or screening reactions. For example prepared xMAP® polystyrene beads were frozen in a special procedure and could be used in tests after defreezing with maintained activity. Experiments have shown, that the freezing process has to take place very quick. The faster the temperature is lowered, the more protecting the freezing takes place in view of the activity of the coupled biologic fragment, group, molecule or structure like an enzyme. Especially a shock freezing procedure leads to storage stable materials with maintained activity. The shock freezing can be carried out at a temperature in the range of about −20 up to −196° C., most preferably it is carried out at a temperature of about −196° C. in liquid nitrogen. After shock-freezing the frozen substrate-coupled beads are stored at a temperature in the range of about −20 up to −196° C., preferably at a temperature in the range of about −40 up to −140° C., especially in a range of −60 up to −100° C. and most preferred in a temperature range of about −70 up to −90° C.

But additionally it was found, that the biologic activity, especially the enzyme activity could be kept more stable if the substrate-coupled bead stocks prepared for example for enzymatic reactions were suspended in suitable mixtures comprising some preservative additives before freezing. By various experiments it could be shown, that the properties of these substrate-coupled beads remain nearly unchanged, if the shock-freezing takes place in presence of different additives, which may be added into the storage buffer solution containing the substrate-coupled beads. Suitable stabilizing additives are for example poly hydroxyl alcohols (polyols), having two or more OH-groups, like glycol, glycerol, propylene glycol, or sugars like sucrose, fructose, ribose, glucose, trehalose, raffinose, or polyhydroxy alcohols like mannitol, sorbitol, isomalt, lactit, xylit, threit, erythrit, fructose or glucose, trehalose, raffinose xylitol, or the like are also applicable in the method of the present invention. But the most suitable stabilizing polyols are glycerol, and sugars selected from the group sucrose, fructose and ribose. The most preferred additives are glycerol and sucrose. As already mentioned polyols or sugars can be added as such. Preferably glycerol and/or sucrose are used as such or in combination as stabilizing additives.

An improved activity is found if at least one compound selected form one of these groups is added to the substrate coupled bead suspension before freezing. These polyols may also be added as such or in a combination of two or more polyols or sugars. In particular, if suitable amounts of glycerol or sucrose are added, the activity is maintained for a long time.

In general the sugar alcohols are applied in a suspension comprising the substrate-coupled xMAP® beads, if needed in combination with further buffering additives.

In order to prepare the storage stable substrate-coupled beads the beads are separated from the reaction solution as described for example in WO 2007/009613 A1 and whose disclosure is incorporated herewith by reference. The substrate-coupled beads are re-suspended preferably in an aqueous solution containing salts like NaCl, KCl or the like, and a buffer system which is effective in a pH range between 6 and 8, especially between pH 7.0 and 7.4. As suitable basis for the preparation of substrate coupled beads for example xMAP® beads can be used. But also beads of other origins may be used for this application on the condition that the needed substrates for the reaction may be coupled at the surface of the beads and that the beads may be identified correctly after reaction with a tested molecule. Persons skilled in the art know different particulate polymers, which can be used for this application as can be seen in table 1. But most preferred are Luminex® xMAP® beads for the present application, because these beads are characterized very well and calibrated. They can be used together with a flow cytometer, which is part of a compact analyzing system that identifies each microsphere particle, and also any reporter dye captured during the assay. Many readings can be made on each bead set, further validating the results.

As already mentioned, it is advantageous to use a buffering system for the preparation of the bead suspension. Suitable buffers are Tris based or phosphate buffered. Preferred systems for enzymatic reactions are Tris-based or MOPS based buffer systems. The adjusted pH during the enzymatic reaction depends on the enzyme, which is used. Sometimes it is advantageous for the reaction, if the suspension comprises at least one solvent besides of water. It is self-evident that the added solvents have to be chosen from those solvents, in which the bead coding fluorescent dyes are insoluble, so that the dyes will not be washed out.

The prepared substrate-coupled bead suspension in general may contain solvents including water in amounts in the range from 10 up to 90% by weight. If these suspensions contain solvents besides of water, the amount may be preferably in the range of about 30-60% by weight related to the total amount of solvents, and particularly preferred in a rage of about 40-50% by weight. But suspensions are especially preferred comprising only water as solvent and wherein the water content is less than 50% by weight but more than 10% by weight related to the whole suspension.

The favorable procedure of this new storing method can be shown by working examples especially by freezing beads in 10-50% glycerol or 10-40% sucrose, especially in the range of 30-50% glycerol or 10-20% sucrose and most preferred in 30% glycerol or 10% sucrose.

Substrate coupled beads can be produced as follows:

Substrates can be coupled on beads either covalently with typical NHS-ester coupling procedures on polystyrene beads with carboxy-groups on their surface. An alternative way is to couple His-tagged recombinant protein-substrates to polystyrene beads with a Ni-NTA surface. Another option would be the covalent coupling of a specific or Tag-specific antibody to the polystyrene bead. With this specific antibody the protein substrate can be coupled in an indirect way to the polystyrene bead (examples for tag-specific antibodies: anti-His-tag antibody, anti-glutathion-transferase antibody, anti-Maltose binding protein, and others).

As described above the functionalization can take place with biomolecules, which are built from nucleotides or amino acids. Especially the beads can be functionalized by proteins, peptides or cyclic peptides. In addition to this the beads may be bound to chemical entities like small molecules with potential activity as drug useful for screening experiments.

In a preferred embodiment the beads as described are combined with antibodies or other binders, like scaffold proteins as there are for example anticalins, ancyrin repeat proteins, cystein-knot proteins, nanobodies and the like. In another preferred embodiment the beads are functionalized with enzymes, like phosphatases, kinases, lipases and so on. But they can also be functionalized with nucleotide sequences. These nucleotide sequences can occur as primers, DNA or RNA fragments, binding molecules, like aptamers or as larger DNA or RNA structures. The functionalization of said beads with for example antibodies or other structures can be achieved by covalent coupling by NHS-chemistry or by tags, which are captured by the corresponding affinity ligand, for example His-tag—Ni²⁺-NTA, GST-tag—glutathione, S-tag—S-protein.

As mentioned above the functionalized beads can be applied in biological reactions of analytical detection reactions.

Experiments have shown, that all these functionalized beads may be treated as described above in a freezing process and can be stored in said polyol containing suspension for a long time keeping their activities nearly constant.

The present description enables the person skilled in the art to apply the invention comprehensively. In the case of any lack of clarity, it goes without saying that the cited publications and patent literature should be employed. Accordingly, these documents are regarded as part of the disclosure content of the present description.

For better understanding and in order to illustrate the invention, examples are given below which are within the scope of protection of the present invention. These examples also serve to illustrate possible variants. Owing to the general validity of the inventive principle described, however, the examples are not suitable for reducing the scope of protection of the present application to these alone.

It goes without saying to the person skilled in the art that, both in the examples given and also in the remainder of the description, the component amounts present in the compositions always only add up to 100% by weight, based on the composition as a whole, and cannot go beyond this, even if higher values could arise from the percentage ranges indicated.

The temperatures given in the examples and description and in the claims are always quoted in ° C.

Example for the Production of Substrate Coupled Beads:

A tag specific antibody e.g. an anti-His tag antibody is coupled covalently to the surface of carboxylated polystyrene beads in a concentration of 50 μg/ml according to the manufacturer protocol. Recombinant his-tagged kinases are added to anti-his polystyrene beads (20 ng kinase is added to approx 2000 beads). After incubation for one hour additional kinases can be washed away and substrate coupled beads can be resuspended in the respective freezing buffer.

1. REM pictures of unfrozen and frozen/thawed xMAP® beads with glycerol as additive. These pictures show, that the bead shape is not effected by the freeze/thaw process;

and

2. xMAP® data from kinase reactions with unfrozen substrate-coupled beads and frozen/thawed substrate-coupled beads with glycerol or sucrose as additives. The comparison of results of reactions with frozen and non-frozen substrate-coupled beads show, that there are no significant differences in kinase activity signals detectable.

3. xMAP® data from ErbB4 kinase reactions either with ErbB4 kinase which is stored at −80° C. or at 4° C. for a special period of time and then coupled to beads or which is coupled to beads immediately and then stored at −80° C. or at 4° C. for a special period of time. The comparison of results of reactions with ErbB4 kinase stored either solely or coupled to beads show that the coupling to beads stabilizes the enzyme and an overall higher kinase activity can be obtained for a long period of time even the bead-kinase complex is stored at 4° C.

### EXAMPLES

I. xMAP® Bead Shape Control with REM

xMAP® Beads are diluted in buffer solutions containing 30% by weight glycerol. Diluted beads are then shock frozen with liquid nitrogen. Frozen xMAP® beads are thawed quickly at 37° C., vortexed and sonicated for 30 s and visualized with REM (Raster electron microscopy).

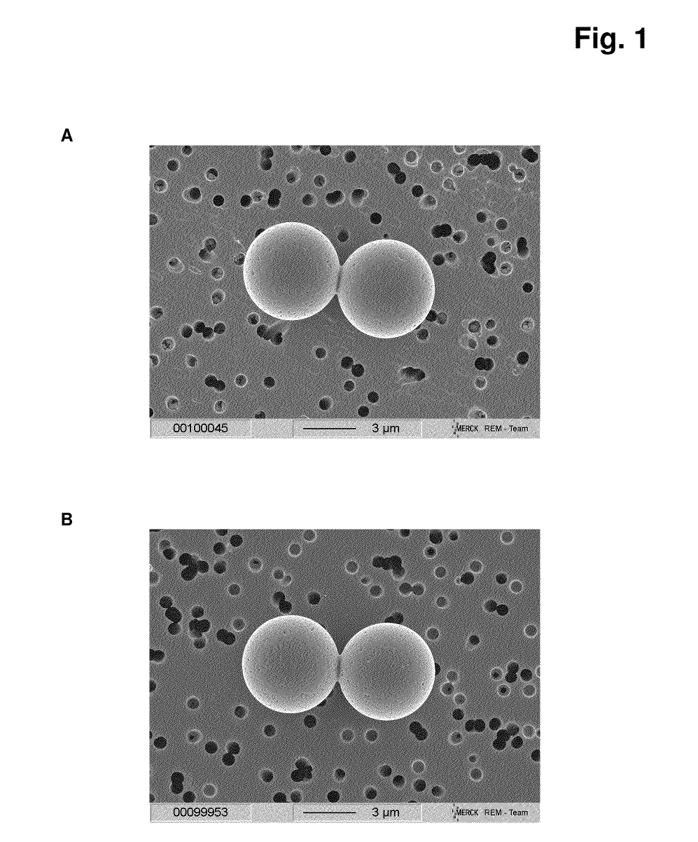

After the freeze/thaw process there are no significant effects on the bead shape visible in comparison to untreated xMAP® beads (see FIG. 1).

FIG. 1: Untreated xMAP® beads are visualized with REM picture (A). The xMAP® beads were diluted in buffer solution containing 30% glycerol and shock frozen with liquid nitrogen, thawed and visualized with REM picture (B). There are no changes visible due to the freezing process.

II. Freezing Kinase Coupled xMAP® Beads—Kinase Activity Measurement

xMAP® beads are coupled with recombinant protein as described by the manufacturer and resuspended in freezing buffer (1% BSA, 0.03% Brij35 in PBS, 30%-50% Glycerol).

Kinase coupled xMAP® beads are shock frozen in liquid nitrogen and thawed quickly at 37° C. Kinase reaction is started with 250 μM ATP and 40 mM MgCl₂ in Assay buffer (20 mM MOPS, 25 mM β-Glycerophosphate, 5 mM EGTA, 1 mM DTT, 1 mM Sodiumvanadate, pH 2 supplemented with 0.1% BSA and 0.03% Brij35) for 30 min at 37° C. with agitation. Kinase reaction is then stopped with 150 mM EDTA. After three wash steps with Detection buffer (1% BSA, 0.03% Brij35 in PBS), phosphorylated tyrosine-residues are detected with a biotinylated anti-phospho-tyrosine antibody (1 h agitation at room temperature) and phycoerythrin-conjugated Streptavidin (45 min agitation at room temperature). Microspheres are analysed in a Luminex¹⁰⁰ machine as described by the manufacturer.

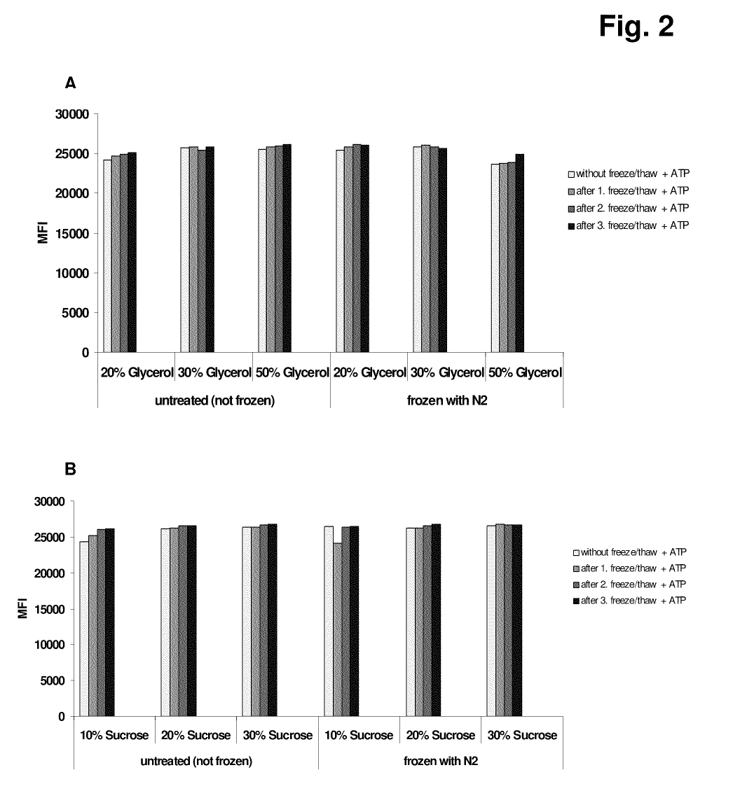

FIG. 2: The activity of FGFR1-Kinase coupled xMAP® beads is shown after shock freezing in liquid nitrogen when buffer solutions with different concentrations of glycerol (20%, 30%, 50%) (A) or sucrose (10%, 20%, 30%) (B) were used.

Comparable kinase activity signals can be obtained for frozen kinase coupled on xMAP® beads and frozen/thawed kinase coupled on beads. Glycerol and Sucrose are both suitable additives for a freezing buffer (FIG. 2).

III. Increased Kinase Stability if Kinase is Coupled to xMAP® Beads

a) Kinase was stored at −80° C.

Recombinant ErbB4 kinase was shock frozen in liquid nitrogen and stored for more than 500 days at −80° C. After thawing the sample at 37° C. the kinase was coupled to S-tag antibody-coupled xMAP® beads. In parallel equal amounts of ErbB4 kinase from the same preparation were shock frozen in liquid nitrogen after coupling to S-tag antibody-coupled xMAP® beads. Aliquots were stored at −80° C. for more than 500 days and thawed individually at 37° C. The kinase reaction was started with 5 μM ATP and 40 mM MgCl₂ in Assay buffer (20 mM MOPS, 25 mM β-Glycerophosphate, 5 mM EGTA, 1 mM DTT, 1 mM Sodiumvanadate, supplemented with 0.1% BSA and 0.03% Brij35) for 30 min at 37° C. with agitation. The reaction was then stopped with 150 mM EDTA. After three wash steps with Detection buffer (1% BSA, 0.03% Brij35 in PBS), phosphorylated tyrosin-residues were detected with a biotinylated anti-phospho-tyrosin antibody (1 h agitation at room temperature) and phycoerythrin-conjugated Streptavidin (45 min agitation at room temperature). Microspheres were analysed in a Luminex200 machine as described by the manufacturer.

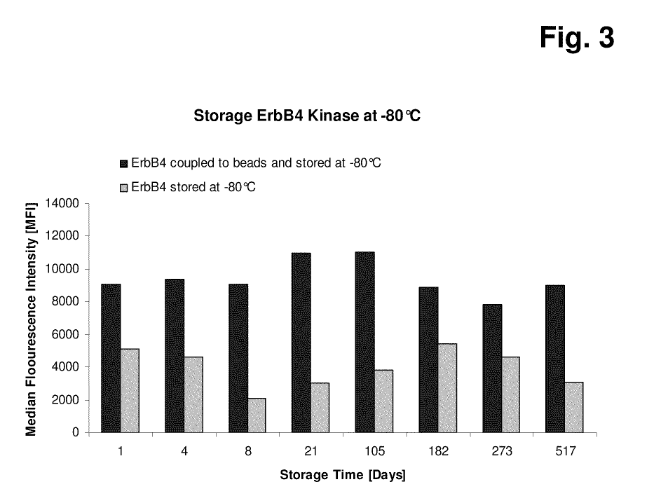

Results of these storage experiments are given in FIG. 3

FIG. 3: ErbB4 kinase is either stored at −80° C. solely for the indicated period of time and then coupled to beads (light blue) or coupled to xMAP® beads immediately and then stored for the indicated period of time (dark blue). The ErbB4 kinase activity is evaluated after a storage period from 1 to 517 days and is shown as Median Fluorescence Intensity.

Kinase activity is improved significantly when ErbB4 kinase is stored already coupled to xMAP beads in comparison to uncoupled kinase stored at −80° C. (FIG. 3). So the bead-kinase complex stabilizes the protein of interest and therefore an overall higher kinase activity can be obtained over a long period of time—in the example as shown the kinase activity is improved by a factor of approx. 2-3 and the bead-coupled kinase is stable over a period of at least 517 days.

b) Kinase was stored at 4° C.

The equivalent experiment is carried out with ErbB4 kinase coupled to beads in advance and after incubating at a storage temperature of 4° C. for up to 517 days.

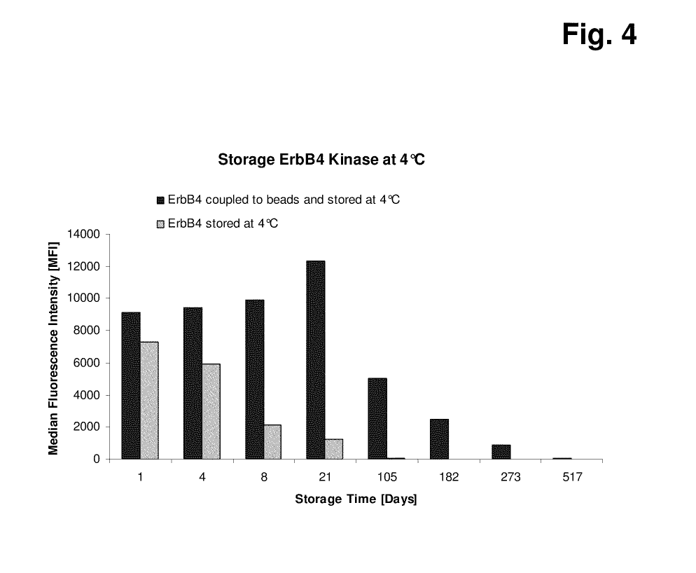

Results of these experiments are shown in FIG. 4

FIG. 4: ErbB4 kinase is either stored at 4° C. solely before coupling (light blue) or coupled directly to xMAP® beads before storing at 4° C. (dark blue). The ErbB4 kinase activity after a storage period from 1 to 517 days is shown in Median Fluorescence Intensity.

The kinase activity at 4° C. is also improved when ErbB4 kinase is stored in a bead-kinase complex (FIG. 4). The kinase, which is stored at 4° C. solely before coupling, shows decreased activity already after 8 days. However, the kinase coupled to beads starts to show decreased activity only after 105 days.

1. Method for a long term storage of substrate-coupled beads, comprising the steps of
a) adding at least one polyhydroxy alcohol or sugar to a suspension of substrate-coupled beads
and
b) storage at a low temperature.

2. Method according to claim 1, comprising the steps of
a) adding at least one polyhydroxy alcohol or sugar to a suspension of substrate-coupled beads
b) shock freezing the resulting composition
and
c) storage at a low temperature.

3. Method according to claim 1 for a long term storage of substrate-coupled polystyrene beads.

4. Method according to claim 1, wherein in step b) the resulting composition is shock frozen in liquid nitrogen.

5. Method according to claim 1, wherein the storage takes place at a temperature of about 4° C., preferably at a lower temperature.

6. Method according to claim 1, wherein the storage takes place at a temperature in the range of −20 up to −196° C., preferably at a temperature in the range of −60 up to −100° C.

7. Method according to claim 1, wherein in step a) at least one polyhydroxy alcohol or sugar selected from the group glycerol, sorbitol, mannitol, isomalt, lactit, xylit, threit, erythrit, sucrose, fructose, trehalose, raffinose and glucose is added.

8. Method according to claim 1, wherein in step a) glycerol and/or sucrose is added.

9. Method according to claim 1, wherein in step a) glycerol and/or trehalose is added.

10. Method according to claim 1, wherein in step a) glycerol and/or fructose is added.

11. Method according to claim 1, wherein in step a) glycerol and/or mannitol is added.

12. Method according to claim 1, wherein in step a) at least one polyalcohol or polyhydroxy sugar is added to the suspension in combination with further additives with buffering and stabilizing properties.

13. Method according to claim 1 for a long term storage of substrate-coupled beads, wherein the beads are coupled to chemical entities like small molecules or molecules built from nucleotides or amino acids or to proteins, peptides or cyclic peptides or to enzymes like phosphatases, kinases, lipases or others.

14. Method according to claim 1 for a long term storage of substrate-coupled beads, wherein the beads are coupled to antibodies or other binders, scaffold proteins like anticalins, ancyrin repeat proteins, cystein-knot proteins, nanobodies, and others.

15. Method according to claim 1 for a long term storage of substrate-coupled beads, wherein the beads are coupled to nucleotide sequences, like primers, DNA or RNA fragments, binding molecules like apatamers, larger DNA or RNA structures.

16. Method according to claim 1 for a long term storage of substrate-coupled beads, wherein the beads are coupled to enzymes like phosphatases, kinases, lipases or others.

17. Method according to claim 1 for a long term storage of substrate-coupled beads, wherein the beads are coupled to kinases.
